(19) United States
(12) Patent Application Publication
(10) Pub. No.: US 2005/0247725 A1
(43) Pub. Date: Nov. 10, 2005

(54) Dispenser

(75) Inventor: Nigel Peter Smith, Liverton, Newton Abbott (GB)

Correspondence Address: WELSH & KATZ, LTD, 120 S RIVERSIDE PLAZA, 22ND FLOOR, CHICAGO, IL, 60606, US

(73) Assignee: Robert McBride Limited, Middleton, Manchester (GB)

(21) Appl. No.: 10/507,187

(22) PCT Filed: Mar. 12, 2003
(86) PCT No.: PCT/GB03/01044

§ 371 Date: Jun. 17, 2005

(30) Foreign Application Priority Data
Mar. 12, 2002 (GB) 0205692.7
Aug. 10, 2002 (GB) 0218655.9

(51) Int. Cl. B67B 7/00; G01F 11/00

(52) U.S. Cl. 222/1

(57) ABSTRACT

The invention provides an adaptation to a rimstick dispenser of the type having a reservoir of active liquid and a flow controller to control the rate at which liquid is dispensed from the reservoir. In accordance with the invention a source of further active substance is provided so as to improve the efficacy of the dispenser, without otherwise affecting the assembly or operation of the dispenser. In one embodiment this source of further active is retained about the outlet neck of the reservoir so as to be sandwiched between the reservoir and the flow controller when the two components are assembled together.

This invention relates to a dispenser and, in particular, to a dispenser for dispensing active substances into a toilet bowl.

### BACKGROUND OF THE INVENTION

In our pending International Patent Application No. PCT/GB00/02552 we describe and claim a dispenser for releasing discrete doses of cleaning and perfuming substance into a toilet bowl, when the toilet is flushed. The dispenser described is one of a number of devices (commonly referred to as ‘liquid, rimsticks’) arranged to be suspended from the rim of the toilet bowl, in the path of the flush water. The active substances are embodied in a liquid or semi-liquid which is stored in a reservoir forming part of the dispenser. This liquid is drawn from the reservoir when the toilet is flushed and released, with the flush water, into the toilet bowl.

There are now proposals to provide liquid rimstick-type dispensers able to dispense a wider variety of active substances, including bleaches. Examples of these proposals are described in International Patent Applications WO b 02/040787, WO 02/040791, WO 02/040792 and WO 02/064898. These units are all specifically designed to provide complete substitutes for known rimstick devices and include separate reservoirs and separate dispensing mechanisms for each substance to be dispensed. As a consequence they are both bulky in form and require extensive investment in tooling prior to manufacture.

It is an object of this invention to provide a dispenser of the liquid rimstick type, and/or a method of adapting a dispenser of the liquid rimstick type, so as to dispense additional active components whilst addressing the problems mentioned above; or which will at least provide a novel and useful choice.

### SUMMARY OF THE INVENTION

Accordingly, in one aspect, the invention provides a method of adapting a liquid rimstick dispenser, said dispenser having a reservoir for a liquid active substance, and a flow controller constructed and arranged to provide a mounting base for said reservoir and to dispense one or more doses of said active substance from said reservoir when a toilet to which said dispenser is fitted, is flushed; said method being characterised by locating a source of further active substance into said flow controller in a manner which exposes said further active substance to the flush water yet which does not prevent the mounting of said reservoir on said flow controller.

Preferably said method comprises locating said source of further active substance in a manner such that said further active substance is dispensed independently from the liquid active substance from said reservoir.

Preferably said method comprises providing said further active substance in non-liquid form.

Preferably said method includes substantially sandwiching said source of further active substance between said reservoir and said flow controller.

As one alternative, said flow controller includes a front face with a free space behind said front face, said method comprising locating said source of further active substance within said free space.

Conveniently said reservoir is provided in the form of a bottle having an outlet neck which bottle, in use, is inverted and said neck engaged with said flow controller, said method preferably comprising locating said source of further active substance about, or adjacent to, said neck. More preferably said method comprises locating said source of further active substance in a tray-like member which is configured to provide an interference fit with said neck.

Preferably said method comprises providing said further active substance in the form of one or more solid blocks of active-containing substance, said active-containing substance being dissolvable in water or physically degradable under the influence of flush water.

Preferably said method comprises providing said further active substance in a form which contains active components selected from a group including halogen release agents, bleaches, Quaternary Ammonium salt based disinfectants, bleach/activator combinations, peroxides, biocides and water softeners.

In a second aspect the invention provides a liquid rimstick dispenser when adapted according to any one of the preceding paragraphs.

In a third aspect, the invention provides a refill unit for a liquid rimstick dispenser which includes:
a reservoir for liquid active substance, and a flow controller constructed and arranged to provide a mounting base for said reservoir and to dispense one or more doses of said active substance from said reservoir when a toilet to which said dispenser is fitted, is flushed, said reservoir having an outlet neck to enable engagement with said flow controller;
said refill unit comprising said reservoir with liquid active substance therein, and a source of further active substance, said source of fisher active substance being located about the outlet neck of said reservoir and being constructed and arranged for simultaneous mounting with said reservoir, on said flow controller.

Preferably said source of further active substance includes a tray-like member in which said further active substance is located.

Preferably said tray-like member is configured to provide an interference fit with said outlet neck.

Many variations in the way the present invention can be performed will present themselves to those skilled in the art. The description which follows is intended as an illustration only of one means of performing the invention and the lack of description of variants or equivalents should not be regarded as limiting. Wherever possible, a description of a specific element should be deemed to include any and all equivalents thereof whether in existence now or in the future. The scope of the invention should be limited by the appended claims alone.

### BRIEF DESCRIPTION OF THE DRAWINGS

The various aspects of the invention, as embodied in working examples, will now be described with reference to the accompanying drawing in which:

FIG. 1: shows a front view of a prior art form of liquid rimstick dispenser,

FIG. 2: shows a view along the line II-II in FIG. 1;

FIG. 3: shows a plan view of a device used to adapt the rimstick dispenser as shown in FIGS. 1 & 2 according to the invention;

FIG. 4: shows a front view of the device shown in FIG. 3;

FIG. 5: shows a side view of the device shown in FIGS. 3 & 4;

FIG. 6: shows a view similar to FIG. 1 but with the device of FIGS. 3 to 5 in position in the rimstick dispenser;

FIG. 7: shows a view along the line VII-VII in FIG. 6.

FIG. 8: shows an exploded isometric view of the components comprising the adapted rimstick dispenser shown in FIGS. 6 & 7;

FIG. 9: shows a view similar to FIG. 1 but of a rimstick dispenser adapted in an alternative manner; and

FIG. 10: shows a view along the line X-X in FIG. 9.

### DETAILED DESCRIPTION OF WORKING EMBODIMENTS

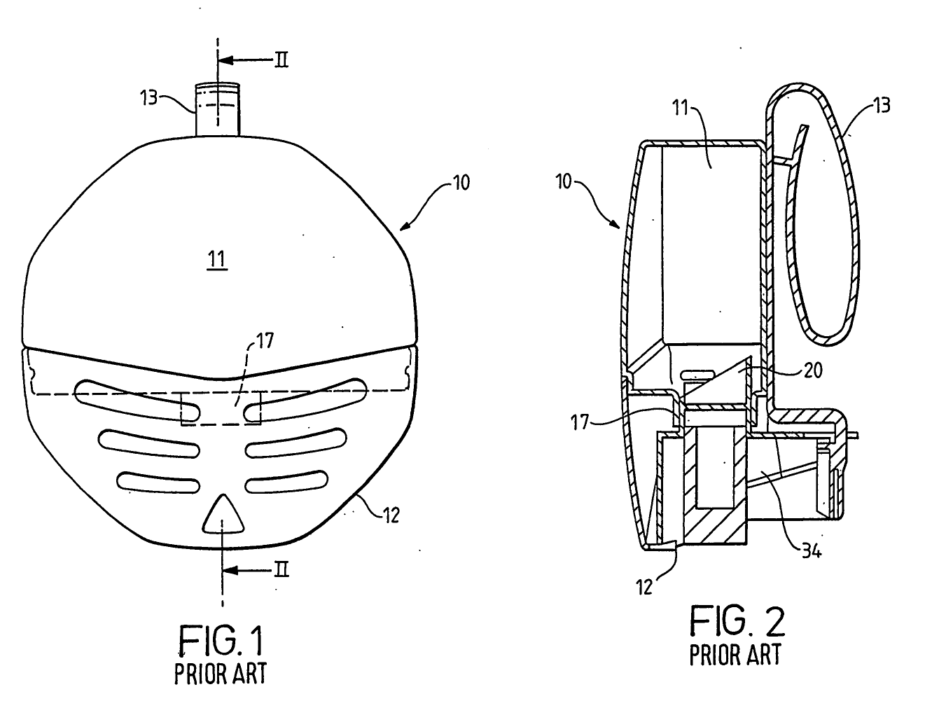

The present invention provides a variation or adaption of a liquid rimstick is toilet dispenser. Such a dispenser is shown at 10 in FIGS. 1 and 2 and comprises a reservoir 11 in which liquid active toilet treatment substances are contained, and a flow controller 12 which lies in the path of the toilet flush water when the dispenser is mounted on a toilet bowl, the, flow controller 12 causing one or more doses of active liquid from the reservoir 11 to be released 20 each time the toilet is flushed. A suspension hook 13 is provided to allow the device 10 to be suspended from the inner edge of a toilet bowl rim.

The precise form of the dispenser 10 does not form part of this invention. It, could, for example, take the form described in our International Patent Application published under No. WO 01/02653, the contents of which are incorporated herein by way of reference.

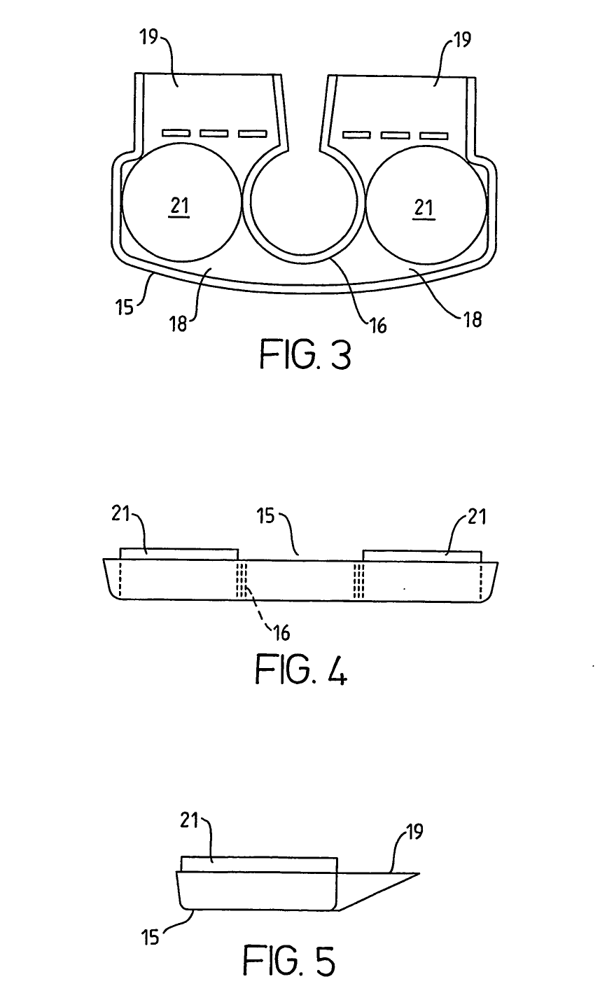

In accordance with the invention, a rimstick dispenser is adapted or enhanced by the addition of a source 15 (FIGS. 3 to 8) of a further active substance. The further active substance in the source 15 will typically include components which provide a cleaning, disinfecting, perfuming and/or de-odorising action to the toilet bowl and thus typically contribute to, or enhance, the action of the liquid substance in reservoir 11.

As can be seen, the source 15 is constructed and arranged so that the contents thereof are exposed to the flush water stream of the toilet. In this way, when the toilet is flushed, further active substance from the source 15 dissolves in, or is degraded by, the flush water and can then be entrained in the flush stream and conveyed into the toilet bowl.

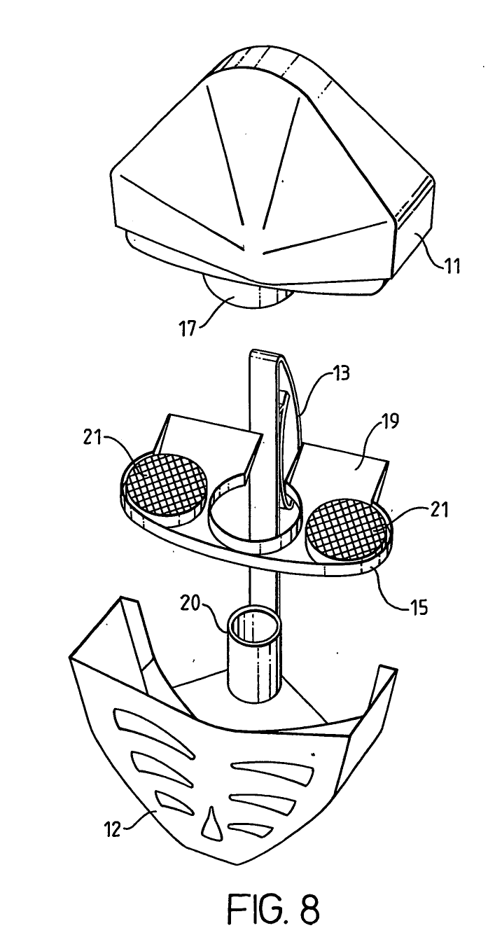

In liquid rimstick dispensers, the reservoir 11 is typically in the form of a bottle having a necked outlet 17 (FIG. 8). In use, the bottle is inverted and the necked outlet clipped into the flow controller 12. In giving effect to the present invention, we have found it particularly advantageous (but by no means essential) to provide the source 15 in a form which affixes to, or adjacent to, the necked outlet 17 of the reservoir 11.

Referring now to FIGS. 3 to 5, the source 15 is shown in the form of a shallow tray-like member having a central sleeve 16 sized to form an interference fit about the necked outlet 17 of the reservoir 11. The source 15 further includes base parts 18 extending to either side of the sleeve 16, on which the further active substance is supported, and two rearwardly extending deflectors 19 constructed and arranged to deflect flush water over the active substance supported on the base parts 18.

The source 15 preferably contains an active substance in a different form or phase to that of the liquid substance contained in reservoir 11. In the particular form shown herein, the further active substance is provided in the form of solid but dissolvable or degradable blocks or tablets 21 which are located on the base parts 18 to either side of the sleeve 16. These blocks or tablets 21 may contain a variety of active substances, such active substances, in general, being of forms which are unsuitable for direct mixing with the substances contained in reservoir 11. By way of example, the active substances contained in blocks or tablets 21 may be selected from a group which includes (but is not necessarily restricted to) halogen release agents; bleaches (both oxygen and chlorine based); Quaternary Ammonium (Quat) salt based disinfectants; bleach/activator combinations; oxygen release materials including percarbonates, perborates, persulphates etc; biocides; water softeners; acids and alkalis.

The additional active components may, as described herein, be included in solid but dissolvable or degradable components such as blocks 21, or may be provided in the form of pastes or even liquids contained in a separate reservoir to the reservoir 11.

The blocks or tablets 21 may be formed in any suitable manner whether known now or developed in the future and may be provided in the form of tablets, extrudates or melts. In common with certain dishwashing and clothes washing tablets, single tablets may include more than one active component. For example, a single tablet might have a layer of bleach on one side and a layer of activator on the other side.

Furthermore, more than one type of tablet might be provided, the combination of tablets serving to release components which could meet in the flush water or toilet bowl water and react. This arrangement could be provided to give, for example, effervescence or a colour change.

Whatever the form, phase or number of the blocks 21, the same may be constructed and arranged to provide continuous emission of one or more fragrances.

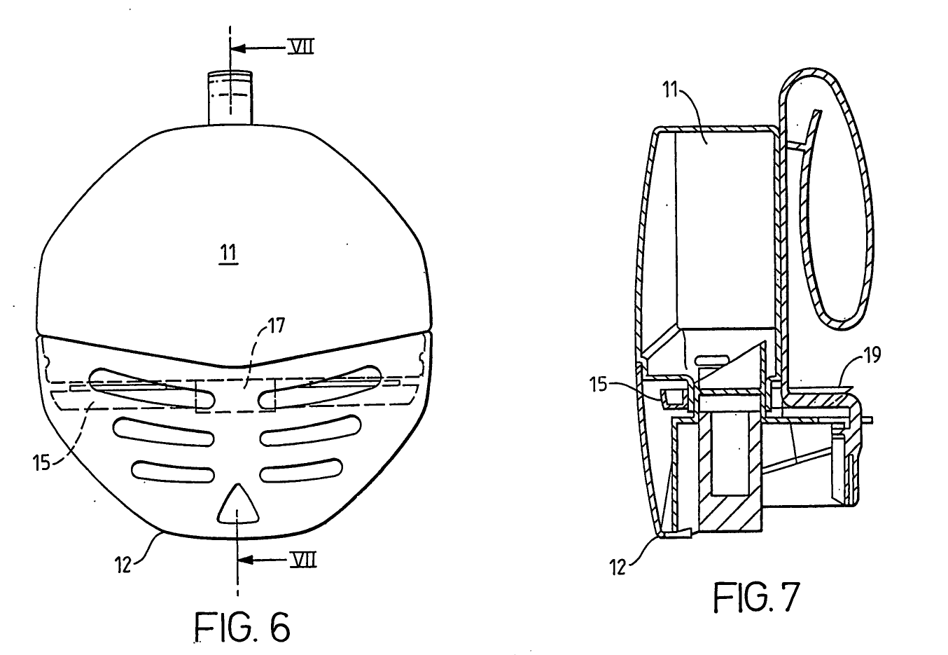

When the unit as described herein is fully functional, the source 15 is sandwiched between the reservoir and flow controller of the conventional rimstick dispenser, as can be seen from FIGS. 6, 7 and 8. As can best be seen in FIG. 8, the source 15 with attached active tablets 21 is clipped about the necked outlet of the reservoir 12 and the reservoir 11 then engaged, in the known manner, with upstanding spigot 20 in the flow controller 12.

The use of the invention is as follows. Upon the toilet being flushed, the components 11 and 12 will not only operate in the conventional manner and dispense a measured dose of liquid active substance from reservoir 11 but also, flush water will be diverted into tray-like member 15 by deflectors 19. This flush water will cause blocks 21 to dissolve or degrade, thus releasing the active substances contained in blocks 21. Successive flushes will cause these active substances to be entrained in the flush water stream and, in turn, to be released into the toilet bowl to add to the action effected by the liquid active substance from reservoir 11.

The precise form of source 15 may be varied to suit particular rimstick configurations and particular toilet rim configurations. For example slots may be provided in the lower walls of the member 15 to enhance the release of active substances from the tray and the form of deflectors 19 may be varied to assist in directing more or less flush water into the tray-like member. It is preferred, however, that the height of the tray-like -member is substantially no greater than the height of the necked outlet 17 so that the source 15 can be accommodated between the assembled reservoir 11 and flow controller 12 thus allowing these two components to interact in their intended manner.

In a further aspect, the invention provides a refill unit for a liquid rimstick dispenser device in which the reservoir 11 and source 15 are provided as a unit. When provided as a refill unit, the sleeve 16 of tray-like member 15 is held about the outer periphery of necked outlet 17 or of a closure (not shown) applied thereto. In this way the liquid and solid active substances are kept apart during storage and display, yet are mounted into the flow controller as one and, although the sources 11 and 15 are configured to release their contents independently of one another, each contributes to the overall efficacy of the rimstick dispenser.

The assembled refill may be mounted in a blister pack, or other suitable form of packaging for distribution and display at point of sale.

It will be appreciated from the above description that the arrangement depicted in FIGS. 3 to 8 is particularly suited to refillable rimstick units. However, there exists (or is perceived to exist) a significant market for a fully disposable unit. To this end, we have devised a form of fully disposable rimstick unit adapted according to the invention.

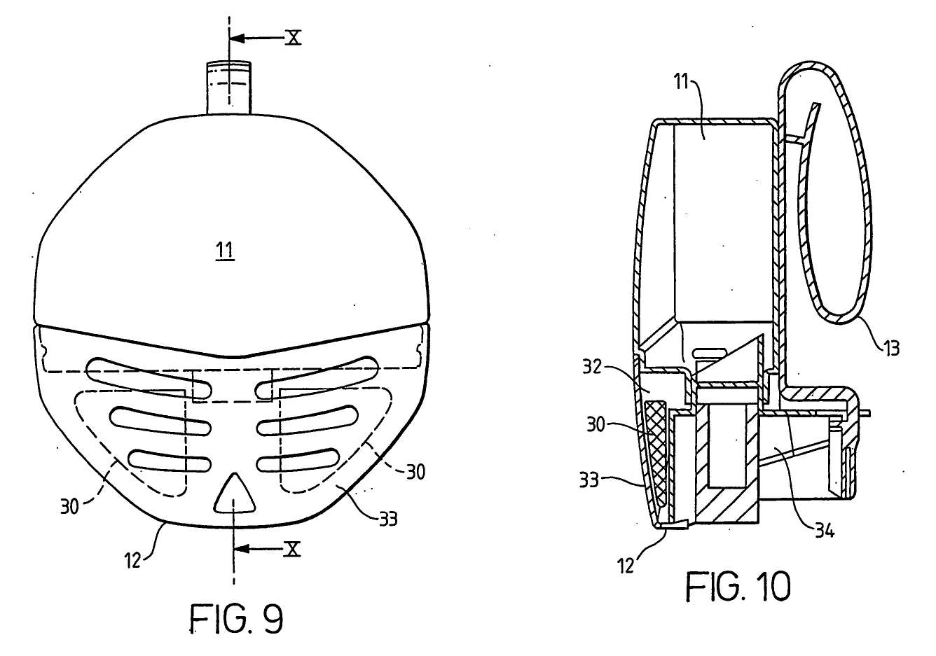

Referring to FIGS. 9 and 10, a rimstick unit 10 is again shown having a reservoir 11 and a flow controller 12. In this embodiment, however, the source of further active substance is not provided in a tray-like member sandwiched between the components 11 and 12, but as tablets 30 moulded to fit within a free space 32 provided behind front face 33 of the flow controller 12.

The tablets 30 may have all the variations in composition and purpose as are set out above in relation to blocks or tablets 21.

The flow controller is the same as that described above and relies on the fact that water deflectors 34 which are provided to deflect water which can mix with liquid from the reservoir 11, will also deflect water into the free space 32. Thus, as flush water enters the rimstick unit from behind, part of the flush water flows forward into the forward part 32 of the unit, and collects about the tablets 30. The action of the water degrades or dissolves the tablets, which then release the active substance(s) contained therein. This creates a pool of water in the free space 32 of the flow controller, heavily concentrated with the active substance(s). When the toilet is flushed thereafter, part of this concentrated pool is displaced from the flow controller and released into the toilet bowl.

It will thus be appreciated that the invention, at least in the case of the working embodiments herein described, provides a method of substantially enhancing the efficacy of a liquid rimstick device by adding a further source of active substance(s), whilst avoiding the problems or potential problems of combining active substances which are generally incompatible. In the particular forms as described herein, this enhanced efficacy is achieved by adapting an existing, known rimstick thus avoiding the need to invest in expensive tooling required in the case of known rimstick devices which dispense more than one active substance.

1. A method of adapting a liquid rimstick dispenser, said dispenser having a reservoir for a liquid active substance, and a flow controller constructed and arranged to provide a mounting base for said reservoir and to dispense one or more doses of said active substance from said reservoir when a toilet to which said dispenser is fitted, is flushed, said method being characterised by locating a source of further active substance into said flow controller in a manner which exposes said further active substance to the flush water yet which does not prevent the mounting of said reservoir on said flow controller.

2. A method as claimed in claim 1, comprising locating said source of further active substance in a manner such that said further active substance is dispensed independently from the liquid active substance from said reservoir.

3. A method as claimed in claim 1, comprising providing said further active substance in non-liquid form.

4. A method as claimed in claim 1, including substantially sandwiching said source of further active substance between said reservoir and said flow controller.

5. A method as claimed in claim 1, wherein said flow controller includes a front face with a free space behind said front face, said method comprising locating said source of further active substance within said free space.

6. A method as claimed in claim 1, wherein said reservoir is provided in the form of a bottle having an outlet neck which bottle, in use, is inverted and said neck engaged with said flow controller, said method comprising locating said source of further active substance about, or adjacent to, said neck.

7. A method as claimed in claim 6, comprising locating said source of further active substance in a tray-like member which is configured to provide an interference fit with said neck.

8. A method as claimed in claim 1, comprising providing said further active substance in the form of one or more solid blocks of active-containing substance, said active-containing substance being dissolvable in water or physically degradable under the influence of flush water.

9. A method as claimed in claim 1, comprising providing said further active substance in a form which contains active components selected from a group including halogen release agents, bleaches, Quaternary Ammonium salt based disinfectants, bleach/activator combinations, peroxides, biocides and water softeners.

10. A liquid rimstick dispenser when adapted according to claim 1.

11. A refill unit for a liquid rimstick dispenser which includes:
a reservoir for liquid active substance, and a flow controller constructed and arranged to provide a mounting base for said reservoir and to dispense one or mote doses of said active substance from said reservoir when a toilet to which said dispenser is fitted, is flushed, said reservoir having an outlet neck to enable engagement with said flow controller;
said refill unit comprising said reservoir with liquid active substance therein, and a source of further active substance, said source of further active substance being located about the outlet neck of said reservoir and being constructed and arranged for simultaneous mounting with said reservoir, on said flow controller.

12. A refill unit as claimed in claim 11, wherein said source of further active substance includes a tray-like member in which said further active substance is located.

13. A refill unit as claimed in claim 12, wherein said tray-like member is configured to provide an interference fit with said outlet neck.
